(19) United States
(12) Patent Application Publication
(10) Pub. No.: US 2026/0336529 A1
(43) Pub. Date: Oct. 29, 2026

(54) GUIDING APPARATUS OF A MULTIPURPOSE MODULE FOR A MOBILITY VEHICLE

(71) Applicants: HYUNDAI MOTOR COMPANY, Seoul (KR); KIA CORPORATION, Seoul (KR); KWANG MYUNG IND. CO., LTD., Gwangmyeong-si (KR); Hyundai Transys Inc., Seosan-si (KR)

(72) Inventors: Jung Hoon Woo, Hwaseong-si (KR); Ji Yun Ha, Hwaseong-si (KR); Soo Bok Kim, Hwaseong-si (KR); Byung Hoon Yoo, Seongnam-si (KR); Min Ho Kang, Hwaseong-si (KR); Tae Hun Cheon, Seongnam-si (KR); Jong Seon Lee, Hwaseong-si (KR); Jae Yong Jang, Suwon-si (KR); Ki Young Yun, Yongin-si (KR); In Gul Baek, Yongin-si (KR); Kook Hee Lee, Suwon-si (KR)

(73) Assignees: HYUNDAI MOTOR COMPANY, Seoul (KR); KIA CORPORATION, Seoul (KR); KWANG MYUNG IND. CO., LTD., Gwangmyeong-si (KR); Hyundai Transys Inc., Seosan-si (KR)

(21) Appl. No.: 19/388,756

(22) Filed: Nov. 13, 2025

(30) Foreign Application Priority Data
Apr. 29, 2025 (KR) 10-2025-0056451

(51) Int. Cl. B60R 11/00; B60N 2/07

(52) U.S. Cl. CPC B60R 11/00; B60N 2/0725; B60R 2011/008

(57) ABSTRACT

A guiding apparatus of a multipurpose module for a mobility vehicle includes a movable member and a rail including at least two path parts that define paths along which the movable member moves. The guiding apparatus changes a position of an auxiliary device to various positions along the paths of the rail, thereby enhancing convenience of using the auxiliary device. In addition, the rail is provided with a cover unit that selectively covers an intersection point of the path parts based on the movement position of the auxiliary device, thereby preventing foreign substances from entering or objects from getting caught at the intersection point of the rail.

### CROSS REFERENCE TO RELATED APPLICATIONS

This application claims priority to Korean Patent Application No. 10-2025-0056451, filed Apr. 29, 2025, the entire contents of which is incorporated herein for all purposes by this reference.

### FIELD

The present disclosure relates to a guiding apparatus of a multipurpose module for mobility vehicles.

### BACKGROUND

Mobility vehicles that transport passengers are typically equipped with various auxiliary devices such as seats for passengers to sit on, stands, and armrests to enhance passenger comfort and convenience.

In addition, for large mobility vehicles, the number of seats, stands, and armrests may increase with the number of passengers, and various other convenience devices may also be provided.

Conventionally, convenience devices including seats are fixed in their originally designed positions. As a result, the interior space of a mobility vehicle is limited, and passengers may experience inconvenience in using each convenience device.

The description provided above as a related art of the present disclosure is intended solely to help understand the background of the present disclosure and should not be construed as being part of the prior art known to those of ordinary skill in the art.

### SUMMARY

The present disclosure provides a guiding apparatus of a multipurpose module for mobility vehicles, which enables the position of an auxiliary device such as a seat or stand to be changed to various positions inside a mobility vehicle, thereby improving the convenience of passengers and the marketability of the mobility vehicle.

The objectives of the present disclosure are not limited to those mentioned above. Other objectives not explicitly stated should be apparent to those of ordinary skill in the relevant technical field from the description below.

In an embodiment of the present disclosure, a guiding apparatus of a multipurpose module for mobility vehicles is provided. The apparatus includes: a movable member on which an auxiliary device is installed; and a rail including at least two path parts that define paths along which the movable member moves on a floor of the vehicle. In particular, ends of the at least two path parts are aligned to form an intersection point, and the intersection point allows the movable member to transition between the at least two path parts and move along the paths in the same direction or different directions.

As an embodiment, the at least two path parts may include: a first path part extending in a first direction; and a second path part extending in a second direction orthogonal to the first direction.

As an embodiment, the first path part and the second path part may be provided at angles at ends thereof, and the ends of the first path part and the second path part may be arranged so as to be orthogonal to each other when matched.

As an embodiment, each of the path parts extends to the same length.

As an embodiment, each of the path parts may include a pair of wall parts, and walls of the pair of wall parts may be spaced apart from each other to form a path through which the movable member can move between the wall parts.

As an embodiment, the movable member may include a peripheral surface on which a plurality of damping parts is disposed, and at least one of the damping parts may come into contact with any of the wall parts of the each of the path parts.

As an embodiment, a catch part protruding along a path of the movable member may be provided on each of the wall parts of the each of the path parts, and a plurality of anti-separation parts may be provided on a peripheral surface of the movable member, so that at least one anti-separation part is matched with the catch part.

As an embodiment, on the floor, a first through hole and a second through hole may be formed in an extension direction of the each of the path parts. In particular, each of the path parts may include an insertion groove formed on a lower surface thereof and aligned with the first through hole. Each of the path parts may further include a fixing hole vertically penetrating the path part and aligned with the second through hole. In an embodiment, a first fixing part may be inserted into the first through hole and the insertion groove, and a second fixing part may be fastened to the second through hole and the fixing hole by penetrating each of the path parts.

As an embodiment, the each of the path parts may include a pair of wall parts and a support part connecting the wall parts, wherein a path along which the movable member can move may be formed between the wall parts and on an upper surface of the support part.

As an embodiment, the apparatus may further include a cover unit movably installed at the end of each of the path parts to selectively cover the intersection point of the rail, such that the intersection point is opened when the movable member moves to the intersection point, and the intersection point is covered when the movable member moves away from the intersection point.

As an embodiment, the cover unit may include: a bracket installed at the end of each of the path parts; a contact link that is rotatably installed on the bracket and extends along a path so as to be in contact with the movable member that moves along a path among the paths; and a cover connected to the contact link, provided to cover the intersection point of the rail, and configured to move to cover or disengage from the intersection point in conjunction with a rotation of the contact link.

As an embodiment, the cover unit may be provided at each of the path parts forming the intersection point of the rail, and the cover may be provided such that when each individual cover unit is operated to cover the intersection point, individual covers of individual cover units move toward a center of the intersection point and comes into alighment.

As an embodiment, the contact link may include a first link rotatably installed, on the bracket, adjacent to a first path part of the path parts and configured to extend so that the movable member moving in the first path part can come into contact with the first link. The contact link may further include a second link rotatably installed, on the bracket, adjacent to a second path part of the path parts and configured to extend so that the movable member moving in the second path part can come into contact with the second link. The contact link may also include a third link configured to rotate in conjunction with a rotation of the first link or the second link, and to which the cover is connected in an interlocking manner.

As an embodiment, the first link may include a first end extending along the path of the first path part and a second end rotatably installed on the bracket. The second end may be formed with a first connection part configured to rotate the third link when the first link rotates due to the movable member entering the intersection point.

As an embodiment, the cover may include: a barrier configured to cover a portion of the intersection point in one of the path parts; and a connection link including a first end connected to the barrier and a second end connected to the third link.

As an embodiment, the barrier may be provided so as to be in contact with the movable member.

As an embodiment, the third link may be formed with a longitudinally extending link connection hole, and the connection link may be formed with an operation pin extended to be inserted into the link connection hole.

As an embodiment, the second link may include a first end configured to contact the movable member and a second end rotatably installed on the bracket. The second end may be formed with a second connection part configured to contact the operation pin and move the cover when the second link rotates due to the movable member entering the intersection point.

As an embodiment, the connection link may be extended in a curved shape, and the bracket may be formed with a guide groove that guides a movement of the connection link along a path corresponding to the curved shape of the connection link.

As an embodiment, a restoration member may be provided on the bracket and connected to each of the first link and the second link, so that each of the first link and the second link is restored to a position where the first link and the second link can contact the movable member.

According to a guiding apparatus of a multipurpose module for mobility vehicles of the present disclosure described above, by changing the position of an auxiliary device such as a seat or stand in the interior of a mobility vehicle to various positions along a rail, the convenience of using the auxiliary device is improved, and the marketability of the mobility vehicle is enhanced as the usability of the interior space is increased by allowing passengers to freely change the interior space of the mobility vehicle.

In addition, the rail is provided with a cover unit that selectively covers the intersection point of the individual rail depending on the movement position of the auxiliary device, thereby preventing foreign substances from entering or objects from getting caught at the intersection point of the rail.

The effect obtained in the present disclosure is not limited to the above-mentioned effects, and other effects not mentioned above may be clearly understood by those having ordinary skill in the art from the following description.

### BRIEF DESCRIPTION OF THE DRAWINGS

FIG. 1 is a view showing a multipurpose module for mobility vehicles according to an embodiment of the present disclosure.

FIG. 2 is a view showing a guiding apparatus of a multipurpose module for mobility vehicles according to an embodiment.

FIG. 3 is a side view showing a path part and a movable member according to an embodiment of the present disclosure.

FIG. 4 is a top view showing a path part and a movable member according to an embodiment of the present disclosure.

FIG. 5 is a view showing a rail according to an embodiment of the present disclosure.

FIG. 6 is a cross-sectional view showing the installation of a path part according to an embodiment of the present disclosure.

FIG. 7 is a view showing a rail according to another embodiment of the present disclosure.

FIG. 8 is a view showing a rail according to an embodiment of the present disclosure installed on the floor of a mobility vehicle.

FIG. 9 is a view showing a cover unit installed on a rail according to an embodiment of the present disclosure.

FIG. 10 is a view showing a bracket, a contact link, and a cover of a cover unit according to an embodiment of the present disclosure.

FIG. 11 is an assembly view of a cover unit according to an embodiment of the present disclosure.

FIG. 12 is a view showing a movable member entering an intersection point in the present disclosure.

FIG. 13 is a view showing the operation of a cover unit as a movable member enters an intersection point in the present disclosure.

FIG. 14 is a view showing a movable member being disengaged at an intersection point in the present disclosure.

FIG. 15 is a view showing a movable member that has disengaged from an intersection point in the present disclosure.

### DETAILED DESCRIPTION

In the following description of the embodiments disclosed herein, detailed descriptions of known technologies related to the present disclosure may be omitted when they are deemed to obscure the essential features of the embodiments. Furthermore, the accompanying drawings are provided only to facilitate understanding of the embodiments disclosed in this specification and are not intended to limit the technical scope of the present disclosure. The spirit and scope of the present disclosure should be understood to encompass all modifications, equivalents, and substitutions that fall within the scope of the present disclosure. The present disclosure is not intended to limit the present disclosure to the described forms or specific fields of application. It is to be understood that various alternative embodiments and modifications, whether explicitly or implicitly disclosed, may be made. Those of ordinary skilled in the art to which the present disclosure pertains should recognize that changes may be made to the form and details of the present disclosure without departing from the scope and spirit of the disclosure.

The present disclosure is described with reference to certain embodiments. However, as will be understood by those of ordinary skill in the art to which the present disclosure pertains, various modifications and alternative implementations of the disclosed embodiments may be made without departing from the spirit and scope of the present disclosure. Accordingly, the following description should be regarded as illustrative and is intended to teach those having ordinary skill in the art how to make and use various embodiments within the scope of the present disclosure. The forms of the disclosure illustrated and described herein are to be understood as exemplary. Equivalent elements, materials, processes, or steps may be substituted for those specifically illustrated and described herein. Terms such as “including”, “comprising”, “incorporating”, “consisting of”, “having”, and “is”, as used in this specification, are intended to be interpreted in a non-limiting manner. In other words, such terms should be construed to include items, components, or elements not expressly listed. In addition, references to the singular form are to be understood as including the plural form as well, unless the context clearly dictates otherwise.

Furthermore, the various embodiments disclosed in the present specification are to be understood as illustrative and descriptive, and are not intended to limit the scope of the present disclosure. All references to “joining” (for example, “attached”, “affixed”, “coupled”, “connected”, and the like) are provided solely to aid in the understanding of the disclosure and are not intended to limit the positioning, orientation, use, or methods disclosed herein. Accordingly, references to joining are to be interpreted broadly. In addition, such references do not necessarily imply that two or more elements are directly connected to each other, unless explicitly stated otherwise. Additionally, all numerical terms or descriptors, such as “first”, “second”, “third”, “primary”, “secondary”, “major”, or any other general or ordinal terms, are to be understood solely as identifiers used to distinguish elements, configurations, variations, or modifications, and are not intended to indicate any order, priority, or preference among such elements. In other words, these terms may be used to describe various components, but the components themselves are not to be limited by such descriptors. This terminology is used solely to distinguish one element from another.

In the following description, suffixes such as “module” and “part” used in reference to components are provided solely for convenience and are used interchangeably without implying any distinct meaning or function.

When it is stated that a certain component is “connected” or “coupled” to another component, it should be understood that the connection or coupling may be direct or indirect, with other intervening components potentially present. In contrast, when a component is described as being “directly connected” or “directly coupled” to another component, it should be understood that no intervening components are present.

Additionally, the terms “unit” or “control unit” included in the name of a component are terms widely used to name a controller that controls a specific function of a vehicle, and do not mean a generic function unit. When a component, controller, device, element, apparatus, or the like of the present disclosure is described as having a purpose or performing an operation, function, or the like, the component, controller, device, element, apparatus, or the like should be considered herein as being “configured to” meet that purpose or to perform that operation or function.

Any number or variety of components in any of the configurations described herein may be included within the disclosure described herein. The components may include any combination of the features described herein and may be arranged in any of the various configurations described herein. The concepts relating to the structure and arrangement of the components disclosed herein, as well as their use and operation, may be applied to any number of embodiments in any combination, and are not limited to the specific embodiments discussed herein. Various embodiments including different features and configurations are described below with reference to the drawings.

Hereinafter, various embodiments disclosed in the present disclosure are described in detail with reference to the accompanying drawings. In the drawings, identical or similar components are denoted by the same reference numerals regardless of the figure in which they appear, and redundant descriptions thereof are omitted for clarity.

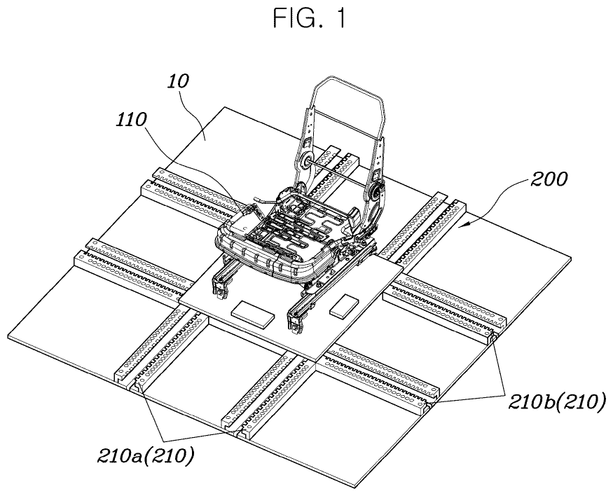

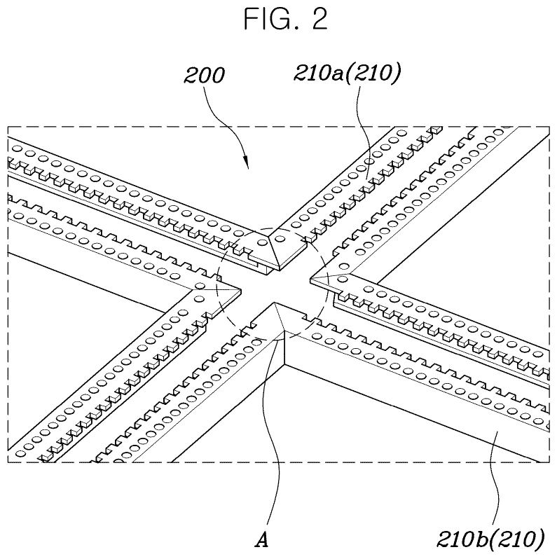

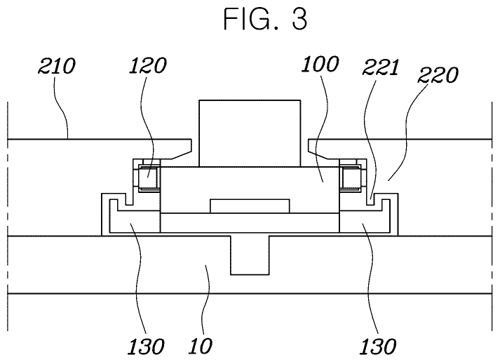

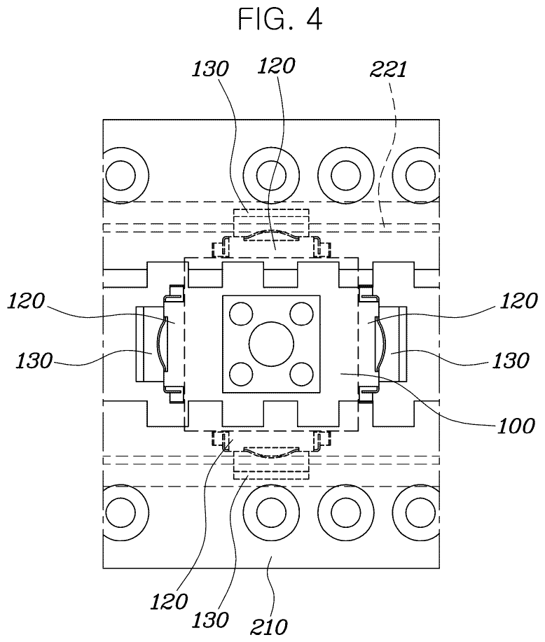

As shown in FIG. 1, FIG. 2, FIG. 3 and FIG. 4, according to an embodiment of the present disclosure, a guiding apparatus of a multipurpose module for mobility vehicles includes a movable member 100 and a rail 200.

In an embodiment, an auxiliary device 110 (e.g., a seat) may be installed in the movable member 100, and the rail 200 includes a plurality of path parts 210 that provides a path along which the movable member 100 can move on a floor 10. At least two path parts 210 have their ends aligned or matched to form an intersection point A.

In this way, the ends of individual path parts 210 are matched to form a path in the same direction or in a different direction at the intersection point A, thereby enabling the movable member 100 to move along the paths of individual path parts 210.

A mobility vehicle may be a means of transportation that provides a space for passengers to board, and can be, for example, a vehicle.

The interior of such mobility vehicle may be provided with the auxiliary device 110 that provides various conveniences to passengers, including a seat, a stand, and a storage box.

According to the present disclosure, the position of the auxiliary device 110 may be changed as the auxiliary device 110 is installed on the movable member 100, and the movable member 100 moves along the rail 200.

The rail 200 may include the plurality of path parts 210 extending from the floor 10, and the plurality of path parts 210 may extend in the same direction or different direction. In this case, the path parts 210 form at least one intersection point A, so that the movable member 100 may move along different path parts 210, thereby being able to move to various positions on the floor 10. The path parts 210 may be formed to extend by being recessed from the floor 10, or may be installed separately on the floor 10, and a mat may be provided above the path along which the movable member 100 moves.

As such, the present disclosure provides the plurality of path parts 210 on the floor 10, and the ends of individual path parts 210 are aligned or matched to form a path in the same direction or in a different direction, so that the moving member 100 may move to various positions along the path parts 210.

As an embodiment according to the present disclosure, the rail 200 may include a first path part 210a extending in one direction and a second path part 210b extending in a direction orthogonal to the direction in which the first path part 210a extends.

The first path part 210a and the second path part 210b are each extended in a straight line. The ends of individual path parts 210 are aligned or matched to form the intersection point A, and the movable member 100 may pass through the intersection point A and move in various directions.

In addition, since the first path part 210a and the second path part 210b are extended orthogonally, interference between movable members 100 moving in the individual path parts 210 is avoided, and the plurality of path parts 210 may be intuitively configured to ensure ease of use.

The ends of the first path part 210a and the second path part 210b may be formed at angles, so that the ends of the first path part 210a and the second path part 210b may be arranged to be orthogonal to each other when matched. The ends of the first path part 210a and the second path part 210b may be formed at an angle of 45 degrees, so that when the ends of the first path part 210a and the second path part 210b are matched, each path part may be arranged at 90 degrees.

According to an embodiment of the present disclosure, the first path part 210a and the second path part 210b may have ends formed at different angles depending on various paths to be implemented, and various shapes may be applied depending on the design.

In this way, as the first path part 210a and the second path part 210b are formed at angles at the ends, the direction in which the movable member 100 moves may be set in various ways. Since the ends of the individual path parts 210 are matched, the occurrence of a free gap (excessive play) between the ends may be prevented, and the structural rigidity of the individual path parts 210 may be ensured by forming a mutually supporting structure.

In addition, the rail 200 may be configured such that each path part 210 extends to the same length. When the length of each path part 210 is matched in this way, packaging and management are easy, and various paths may be intuitively designed by utilizing individual path parts 210 manufactured identically.

The first path part 210a and the second path part 210b described above may be configured to extend in various forms, and additional path parts 210 may be configured to provide various paths.

In one form, the first path part 210a and the second path part 210b are assumed to extend orthogonally.

The movable member 100 is provided to be movable along the path parts 210 that constitute the rail 200. The auxiliary device 110 is installed on the movable member 100, and the position of the auxiliary device 110 may be determined according to the position at which the movable member 100 moves along the path part 210. A plurality of movable members 100 may be provided for one auxiliary device 110.

The movable member 100 may move by sliding along the path part 210, and may move on the path part 210 by applying a ball or cylindrical bearing to the lower surface thereof.

In an embodiment, the path part 210 may include a pair of wall parts 220, and the wall parts 220 are spaced apart from each other to create a path through which the movable member 100 can move between the wall parts 220.

As shown in FIG. 3, each path part 210 may include the wall parts 220 arranged to face each other, and the space between the wall parts 220 forms a path through which the movable member 100 can move. The wall parts 220 are fixed to the floor 10, and a panel constituting the floor 10 in the interior of the mobility vehicle may be joined to the upper surfaces of the wall parts 220.

In this case, the movable member 100 may include a peripheral surface on which a plurality of damping parts 120 are disposed, and at least one damping part 120 may come into contact with one of the wall parts 220 of the path part 210.

As the damping parts 120 are arranged to be spaced apart from each other on the peripheral surface of the movable member 100, the damping parts 120 are interposed between the movable member 100 and the wall parts 220, so that a free gap between the movable member 100 and the wall parts 220 may be absorbed and the impact may be attenuated.

In this disclosure, the path part 210 may be extended such that the first path part 210a and the second path part 210b are perpendicular to each other, and thus the damping parts 120 may be spaced at 90-degree intervals on the peripheral surface of the movable member 100. The damping parts 120 are not limited thereto, and the number and installation location may be changed depending on the path part 210.

In addition, the damping part 120 may be formed to be elastically deformable. However, because the damping part 120 may hinder the movement of the movable member 100 if the damping part 120 is made of a material with high friction, such as rubber, the damping part 120 may be made to generate elastic force through deformation of the shape thereof. For example, the damping part 120 may be formed in a curved and protruding shape at a portion that comes into contact with the wall part 220, and the contact area with the wall part 220 may be reduced by the curved shape, and the impact may be attenuated by the shape deformation. In addition, the damping part 120 may easily fill the free gap between the movable member 100 and the wall part 220 by the curved and protruding shape.

As such, by providing the damping parts 120 on the movable member 100, when the movable member 100 moves along the path part 210, the damping parts 120 form an elastically supporting structure on the wall parts 220 of the path part 210, which stabilizes the structure, and the vibration transmitted through the wall parts 220 is canceled out, thereby preventing discomfort when using the auxiliary device 110.

In an embodiment, a catch part 221 protruding along a path of the movable member 100 is provided on the wall part 220 of the path part 210, and a plurality of anti-separation parts 130 is formed on the peripheral surface of the movable member 100, so that at least one anti-separation part 130 may be matched with the catch part 221.

The catch part 221 protrudes inwardly from the wall part 220, and the anti-separation part 130 of the movable member 100 is formed to extend toward the wall part 220 so as to be caught on the catch part 221, preventing the movable member 100 from separating from the path part 210.

The anti-separation part 130 may be provided at the lowest portion of the movable member 100 so as not to interfere with the damping part 120, and the catch part 221 of the wall part 220 is arranged above the anti-separation part 130 to restrict the anti-separation part 130 from moving upward.

The catch part 221 may be shaped to be bent downwardly from the wall part 220, and the anti-separation part 130 may be shaped to be bent upwardly after extending from the movable member 100 to below the catch part 221. As the end of the catch part 221 and the end of the anti-separation part 130 are shaped to be bent and interlocked, the movable member 100 may be maintained in a fixed position in the path part 210.

In an embodiment, a first through hole 11 and a second through hole 12 are formed on the floor 10 in the extension direction of each path part 210. The path part 210 has, on the lower surface thereof, an insertion groove 230 matching the first through hole 11, and a fixing hole 240 penetrating the path part 210 and matching the second through hole 12. A first fixing part 13 may be inserted into the first through hole 11 and the insertion groove 230, and a second fixing part 14 may be fastened to the second through hole 12 and the fixing hole 240 by penetrating the path part 210.

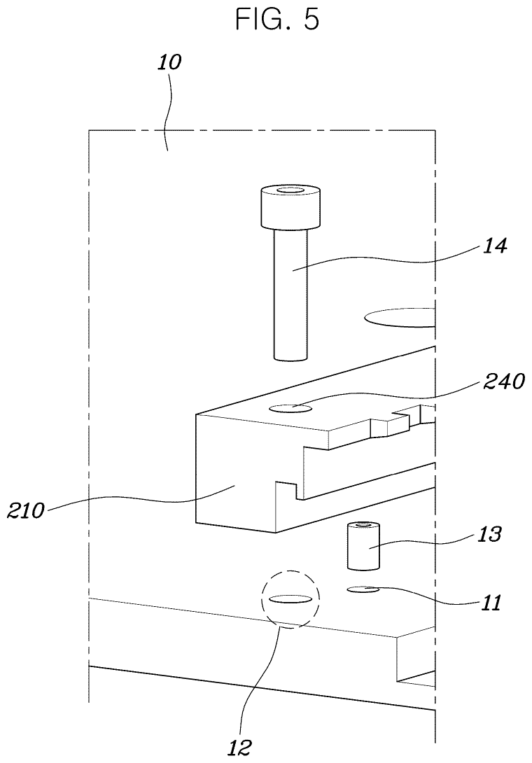

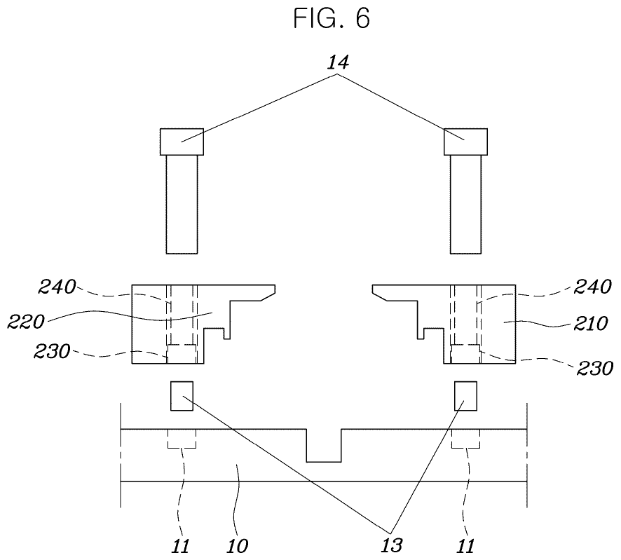

As shown in FIG. 5 and FIG. 6, on the floor 10, the first through hole 11 and the second through hole 12 may be spaced apart from each other, and the first through hole 11 and the second through hole 12 may be arranged in a straight line matching the longitudinal direction of each path part 210.

Each path part 210 is provided with the insertion groove 230 matching the first through hole 11 and the fixing hole 240 matching the second through hole 12. The first fixing part 13 is inserted into the first through hole 11 and the insertion groove 230, and the second fixing part 14 is inserted into the second through hole 12 and the fixing hole 240, so that the path part 210 may be fixed to the floor 10.

In this case, the insertion groove 230 is formed on the lower surface of the path part 210, and the first fixing part 13 is formed of a pin and inserted into the first through hole 11 and the insertion groove 230. In other words, the first fixing part 13 is used to position and temporarily fix the path part 210 on the floor 10, so that the path part 210 is placed at the designated position on the floor 10.

The fixing hole 240 is formed to penetrate the path part 210 vertically, and the second fixing part 14 is formed of a bolt and may be fastened to the second through hole 12 and the fixing hole 240. In other words, the second fixing part 14 is used to completely fix the path part 210 on the floor 10, and ensures that the path part 210 is maintained in a fixed state on the floor 10.

Accordingly, when installing the path part 210 on the floor 10, the first fixing part 13 may be fastened first and then the second fixing part 14 may be fastened, and since the first fixing part 13 and the second fixing part 14 are spaced apart from each other, the twisting of the path part 210 installed on the floor 10 may be prevented and the fastening rigidity may be secured.

As another embodiment of the path part 210, the path part 210 may include a pair of wall parts 220 and a support part 250 connecting the wall parts 220, and a path along which the movable member 100 can move may be formed between the wall parts 220 and on the upper surface of the support part 250.

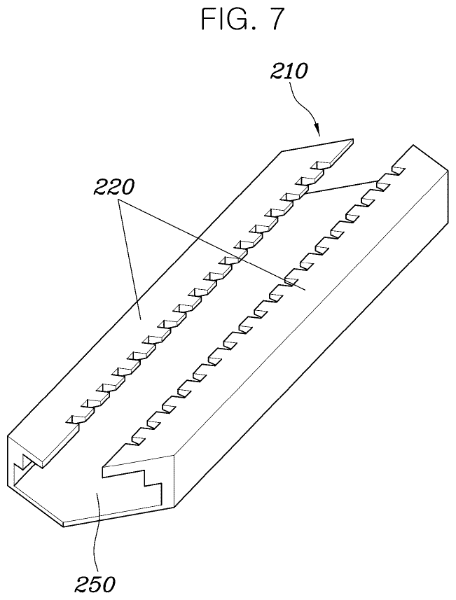

As shown in FIG. 7, the path part 210 may be provided in an integrated form of the wall parts 220 and the support part 250, and the path part 210 may be installed on the floor 10 by fixing the support part 250 to the floor 10.

In addition, the space between the wall parts 220 forms a path along which the movable member 100 moves, and a low-friction coating or bearing structure may be applied to the upper surface of the support member 250 so that the movable member 100 can move smoothly.

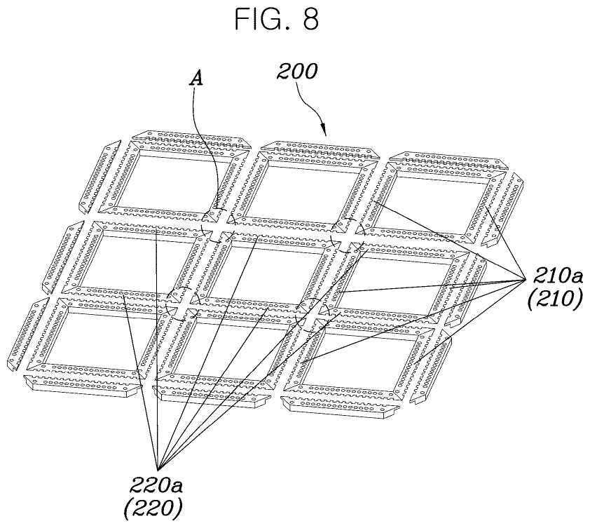

The path part 210 according to the various embodiments of the present disclosure described above may be selectively applied according to the design requirements of the mobility vehicle, and the path part 210 may be designed in various ways on the floor 10 in the interior of the mobility vehicle. For example, as shown in FIG. 8, the first path part 210a and the second path part 210b may be arranged in the front, rear, and both sides, so that the movable member 100 on which the auxiliary device 110 is installed may move to various positions in the front, rear, left, and right directions.

In an embodiment of the present disclosure, the apparatus may further include a cover unit 300 that is movably installed to selectively cover the intersection point A of the rail 200 at the end of each path part 210, thereby opening the intersection point A when the movable member 100 moves to the intersection point A and covering the intersection point when the movable member 100 moves away from the intersection point A.

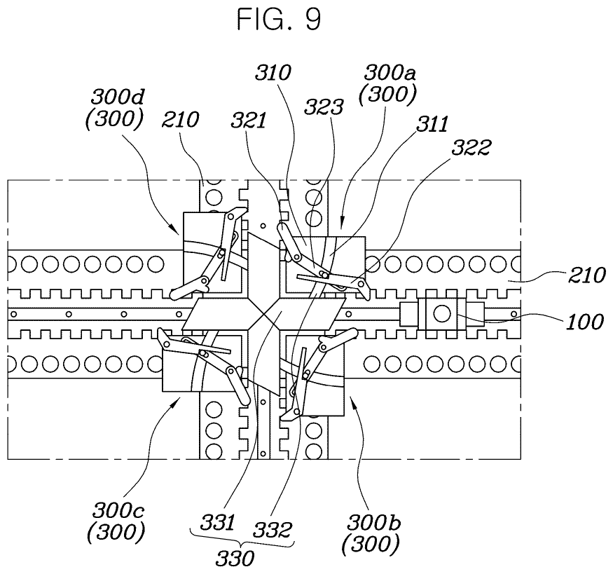

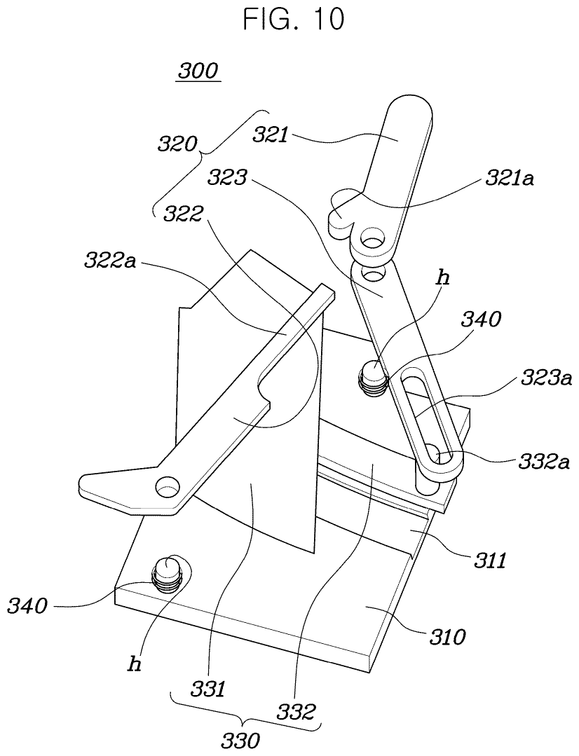

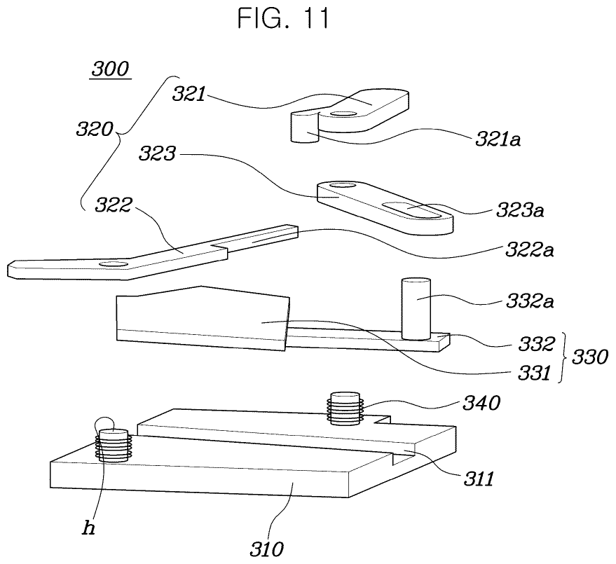

As shown in FIG. 9, FIG. 10 and FIG. 11, the cover unit 300 is provided for each path part 210 of the rail 200, and as the cover unit 300 is installed at the end of the path part 210 so as to cover the intersection point A formed by the individual path parts 210.

The cover unit 300 covers or opens the intersection point A depending on the position of the movable member 100. When the movable member 100 moves on the path part 210 and enters the intersection point A, the cover unit 300 is operated by the movable member 100 to open the intersection point A, thereby allowing the movable member 100 to pass through the intersection point A. In addition, when the movable member 100 moves out of the intersection point A of the path part 210, the cover unit 300 closes the intersection point A to prevent foreign substances, objects, etc. from entering the intersection point A.

The cover unit 300 according to an embodiment of the present disclosure is described in detail. The cover unit 300 may include: a bracket 310 installed at the end of the path part 210; and a contact link 320 that is rotatably installed on the bracket 310 and extends along a path so as to be in contact with the movable member 100 that moves in the path part 210. The cover unit 300 may also include a cover 330 connected to the contact link 320, provided to cover the intersection point A of the rail 200. In particular, the cover 330 may move to cover or disengage from the intersection point A in conjunction with the rotation of the contact link 320.

The bracket 310 is installed in the path part 210 and is provided at the end of each path part 210, so that the cover 330 moved via the contact link 320 may move to cover the intersection point A formed by the individual path parts 210.

The contact link 320 includes at least one link and is rotatably installed on the bracket 310. The contact link 320 is provided to be in contact with the movable member 100 that moves on the path part 210 so as to rotate in conjunction with the movement of the movable member 100.

The cover 330 may be connected to the contact link 320 and moved to cover the intersection point A or move away from the intersection point A depending on the rotational position of the contact link 320. The cover 330 may be connected to the contact link 320 via a link and may be configured to cover the intersection point A.

To be specific, the cover unit 300 is provided at the individual path part 210 forming the intersection point A of the rail 200, and the cover 330 may be formed so that when each cover unit 300 is operated to cover the intersection point A, the covers 330 of individual cover units 300 are gathered toward the center of the intersection point A and match.

As shown in FIG. 9, the cover unit 300 is provided for each path part 210, and each cover unit 300 is provided at the end of the path part 210, so that the cover units 300 are arranged adjacently with the intersection point A as the center.

In this case, the cover 330 of the cover unit 300 is formed to cover a portion of the individual path part 210 and a portion of the intersection point A, so that when each cover unit 300 is operated to cover the intersection point A, the cover 330 of each cover unit 300 moves in a folded form toward the center of the intersection point A to cover a portion of the individual path part 210 and the intersection point A. Accordingly, the cover 330 of each cover unit 300 may be formed such that each cover 330 matches the intersection point A by angularly forming a portion thereof matching the intersection point A so that each cover 330 matches the other when positioned to cover the intersection point A. In addition, the cover 330 may be extended to cover a portion of each path part 210 along with the intersection point A, thereby covering the periphery centered on the intersection point A.

The contact link 320 that moves the cover 330 in conjunction with the movement of the movable member 100 may consist of a first link 321, a second link 322, and a third link 323.

As shown in FIG. 9, the first link 321 is rotatably installed adjacent to one of the path parts 210 on the bracket 310, and may be extended so that the movable member 100 moving in one of the path parts 210 may come into contact with the first link 321. The first link 321 is rotatably installed on the bracket 310 via a hinge pin h and may be extended so as to be positioned on the path of one of the path parts 210.

The second link 322 is rotatably installed adjacent to another of the path parts 210 on the bracket 310, and may be extended so that the movable member 100 moving in another of the path parts 210 may come into contact with the second link 322. The second link 322 is rotatably installed on the bracket 310 via a hinge pin h, and may be extended so as to be positioned on the path of another of the path parts 210 at a different location from the first link 321.

The third link 323 rotates in conjunction with the rotation of the first link 321 or the second link 322, and to which the cover 330 may be connected in an interlocking manner. The third link 323 is rotated in conjunction with the rotation of one of the first link 321 and the second link 322 or each link, which are linked to the movement of the movable member 100, and by connecting with the cover 330, moves the cover 330 to or away from the intersection point A of the path part 210.

In an embodiment, the first link 321 has one end extending along the path of one of the path parts 210 and the other end rotatably installed on the bracket 310, and may have a first connection part 321a formed at the other end that rotates the third link 323 when the movable member 100 enters the intersection point A. In other words, the first link 321 has one end extending along the path of the first path part 210a so as to be able to contact the movable member 100 that moves along the first path part 210a, and the other end is formed with the first connection part 321a that rotates the third link 323 when the first link 321 rotates. In this case, the first connection part 321a contacts the third link 323 when the first link 321 rotates due to the movable member 100 entering the intersection point A, thereby rotating the third link 323. At this time, the third link 323 may move in a direction in which the cover 330 moves away from the intersection point A.

In an embodiment, the cover 330 may include: a barrier 331 formed to cover a portion of the intersection point A in one of the path parts 210; and a connection link 332 whose one end is connected to the barrier 331 and whose other end is connected to the third link 323.

As such, the cover 330 includes the barrier 331 and the connection link 332, and the connection link 332 is connected to the barrier 331 at one end and moves together with the barrier 331, and the other end is connected to the third link 323 so as to move in conjunction with the rotation of the third link 323.

In this case, the third link 323 may be provided with a longitudinally extending link connection hole 323a, and the connection link 332 may be provided with an operation pin 332a extended to be inserted into the link connection hole 323a. The link connection hole 323a extends lengthwise in the third link 323 and may be formed at a location distant from the first link 321.

The operation pin 332a protrudes from the connection link 332 to be inserted into the link connection hole 323a. Because the operation pin 332a moves along the extension direction of the link connection hole 323a, when the third link 323 rotates, the operation pin 332a may be moved to move the barrier 331, or when the barrier 331 moves, the operation pin 332a may be moved in the link connection hole 323a to rotate the third link 323, thereby rotating the first link 321 or the second link 322.

In addition, the barrier 331 configured to be in contact with the movable member 100, so that the connection link 332 may be rotated by the movable member 100 moving along the path part 210. Accordingly, when the movable member 100 moves along the path part 210 and pushes the barrier 331, each link including the connection link 332 connected to the barrier 331 rotates, so that the barrier 331 can open the intersection point A.

The second link 322 may have one end extending along the path of one of the path parts 210 and the other end rotatably installed on the bracket 310, and may have a second connection part 322a formed at the other end that contacts the operation pin 332a to move the cover 330 when the second link 322 rotates as the movable member 100 enters the intersection point A.

In other words, the second link 322 has one end extended along the path of the path part 210 and may contact with the movable member 100 that moves along the path part 210, and the other end has the second connection part 322a formed to contact the operation pin 332a so as to be linked to the cover 330. The second connection part 322a contacts the operation pin 332a when the second link 322 rotates due to the movable member 100 moving to the intersection point A, thereby rotating the connection link 332, and the barrier 331 may be moved away from the intersection point A by the rotation of the connection link 332.

In addition, the connection link 332 may be extended in a curved manner, and a guide groove 311 may be formed in the bracket 310 to guide the movement of the connection link 332 by extending to match the curved shape of the connection link 332.

In other words, the cover 330 moves in a curved shape due to the rotation of individual link when covering the intersection point A or moving away from the intersection point A. As a structure for guiding the movement of the cover 330, the guide groove 311 is formed in the bracket 310, and a portion of the connection link 332 that extends in a curved manner is inserted into the guide groove 311 and moved along the guide groove 311, thereby stabilizing the movement of the barrier 331 moving to or away from the intersection point A. In addition, since the connection link 332 is fixed in the guide groove 311 of the bracket 310 so that the movement of the connection link 332 is restricted only in a set direction, structural stability and operability related to the connection of individual links may be ensured.

In an embodiment, restoration members 340 may be provided on the bracket 310 and respectively connected to the first link 321 and the second link 322. The restoration members 340 are configured to restore each of the first link and the second link 322 to a position where the first link and the second link 322 can contact the movable member 100 after being rotated or displaced. The restoration member 340 may include a spring, and various means for returning the position of a component to the original position thereof may be applied.

The restoration member 340 is provided on each of the first link 321 and the second link 322 of each cover unit 300 so that the first link 321 and the second link 322 return to the original positions thereof. In this case, the original positions of the first link 321 and the second link 322 may be positions where the first link 321 and the second link 322 are arranged on the path of the path part 210.

With this configuration, the cover unit 300 may be operated to cover the intersection point A again when the movable member 100 that moves away from the intersection point A.

The operation of the cover unit 300 described above is as follows.

This is according to an embodiment, and a first cover unit 300a, a second cover unit 300b, a third cover unit 300c, and a fourth cover unit 300d are provided in the respective path part 210 centered on the intersection point A.

According to this, FIG. 9 shows a state in which the cover 330 of the cover unit 300 covers the intersection point A.

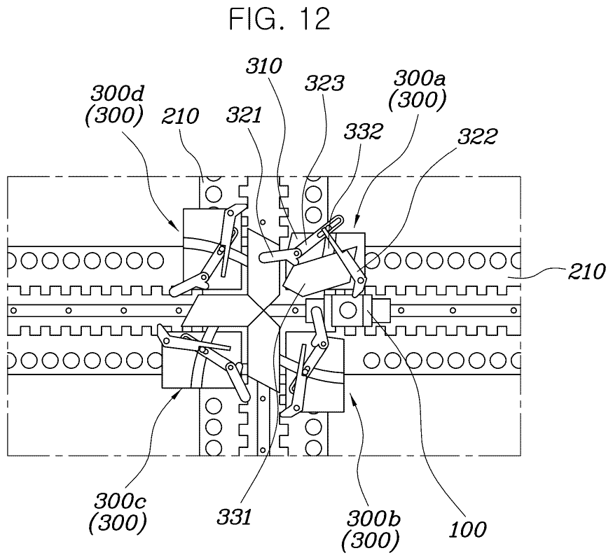

In this case, as shown in FIG. 12, when the movable member 100 moves to the intersection point A, the second link 322 of the first cover unit 300a is pushed and rotated by the movable member 100, thereby rotating the cover 330 so that the cover 330 disengages from the intersection point A.

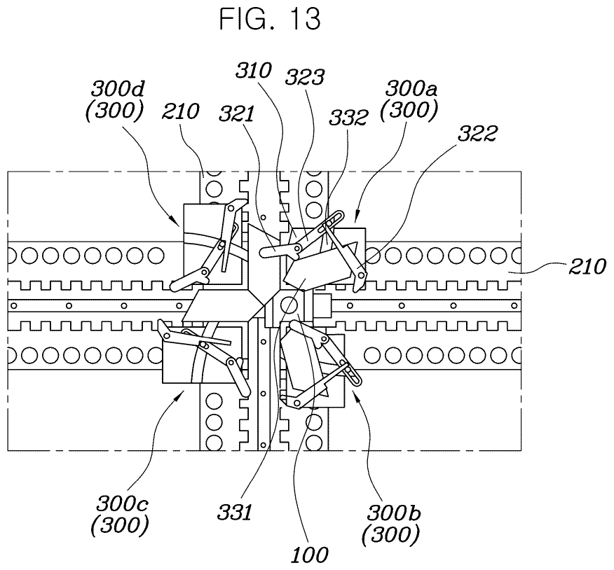

In addition, as shown in FIG. 13, the fourth cover unit 300d rotates the cover 330 by the third link 323 to disengage the cover 330 from the intersection point A as the first link 321 is pushed and rotated by the movable member 100.

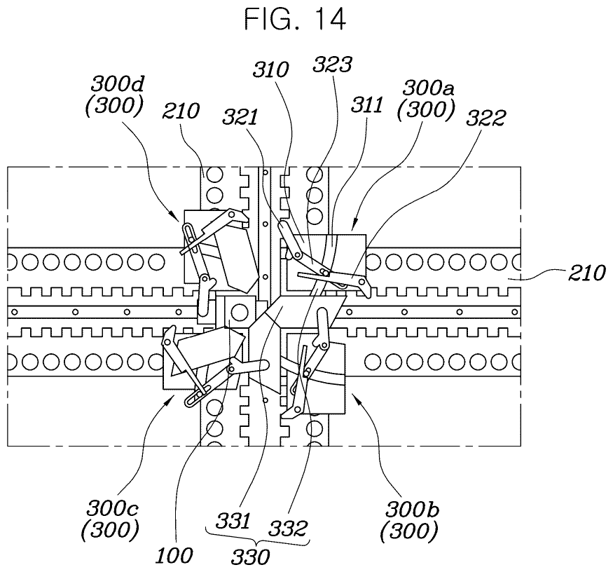

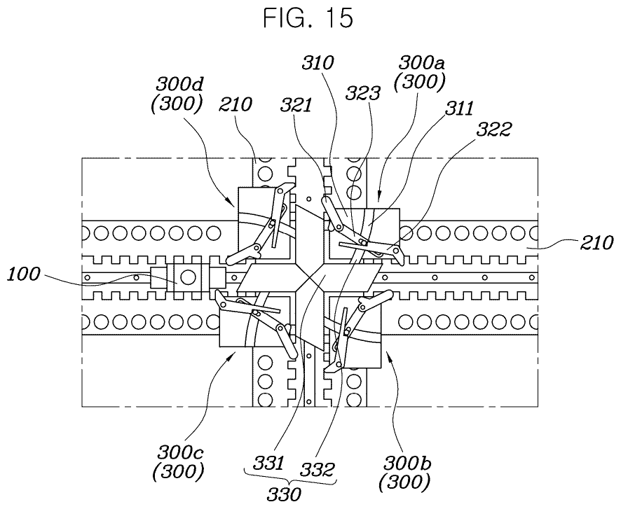

Thereafter, when the movable member 100 shown in FIG. 14 continues to move, the movable member 100 moves while pushing and rotating each cover 330 of the second cover unit 300b and the third cover unit 300c and passes through the intersection point A, and as shown in FIG. 15, the cover 330 of each cover unit 300 is moved to cover the intersection point A by the restoration members 340 that restore each link to the original position thereof.

According to the guiding apparatus of a multipurpose module for mobility vehicles of the present disclosure described above, by changing the position of an auxiliary device such as a seat or stand in the interior of a mobility vehicle to various positions along the rail, the convenience of using the auxiliary device is improved, and the marketability of the mobility vehicle is enhanced as the usability of the interior space is increased by allowing passengers to freely change the interior space of the mobility vehicle.

In addition, the rail is provided with the cover unit that selectively covers the intersection point of the individual rail depending on the movement position of the auxiliary device, thereby preventing foreign substances from entering or objects from getting caught at the intersection point of the rail.

Although the present disclosure was provided above in relation to specific embodiments shown in the drawings, it is apparent to those having ordinary skill in the art that the present disclosure may be changed and modified in various ways without departing from the scope of the present disclosure, which is described in the following claims.

1. A guiding apparatus of a multipurpose module for a mobility vehicle, the apparatus comprising:
a movable member on which an auxiliary device is installed; and
a rail including at least two path parts that define paths along which the movable member moves on a floor of the mobility vehicle,
wherein ends of the at least two path parts are aligned to form an intersection point, and the intersection point allows the movable member to transition between the at least two path parts and move along the paths in a same direction or different directions.

2. The apparatus of claim 1, wherein the at least two path parts comprises:
a first path part extending in a first direction; and
a second path part extending in a second direction orthogonal to the first direction.

3. The apparatus of claim 2, wherein the first path part and the second path part are provided at angles at ends thereof, and the ends of the first path part and the second path part are arranged to be orthogonal to each other when matched.

4. The apparatus of claim 1, wherein each of the at least two path parts extends to the same length.

5. The apparatus of claim 1, wherein each of the at least two path parts includes a pair of wall parts,
wherein walls of the pair of wall parts are spaced apart from each other to form a path through which the movable member moves.

6. The apparatus of claim 5, wherein the movable member comprises a peripheral surface on which a plurality of damping parts is disposed, and wherein at least one of the plurality of damping parts is configured to come into contact with a wall part among the pair of wall parts.

7. The apparatus of claim 5, wherein a catch part protruding along a path of the movable member is provided on each of the pair of wall parts of the each of the at least two path parts, and a plurality of anti-separation parts is provided on a peripheral surface of the movable member, so that at least one anti-separation part is matched with the catch part.

8. The apparatus of claim 1, wherein:
a first through hole and a second through hole are formed on the floor in an extension direction of each of the at least two path parts;
each path part of the at least two path parts includes:
an insertion groove formed on a lower surface thereof and aligned with the first through hole, and
a fixing hole vertically penetrating the path part and aligned with the second through hole; and
a first fixing part is inserted into the first through hole and the insertion groove, and a second fixing part is fastened to the second through hole and the fixing hole by penetrating each of the at least two path parts.

9. The apparatus of claim 1, wherein each of the at least two path parts includes a pair of wall parts and a support part connecting each of the pair of wall parts, and
wherein each path along which the movable member moves is formed between the pair of wall parts and on an upper surface of the support part.

10. The apparatus of claim 1, further comprising:
a cover unit movably installed at the end of each of the at least two path parts and configured to selectively cover the intersection point of the rail such that the intersection point is opened when the movable member moves to the intersection point, and the intersection point is covered when the movable member moves away from the intersection point.

11. The apparatus of claim 10, wherein the cover unit comprises:
a bracket installed at the end of each of the at least two path parts;
a contact link rotatably installed on the bracket and configured to extend along a path to be in contact with the movable member that moves along a path among the paths; and
a cover connected to the contact link, provided to cover the intersection point of the rail, and configured to move to cover or disengage from the intersection point in conjunction with a rotation of the contact link.

12. The apparatus of claim 11, wherein
the cover is configured such that, when each individual cover unit operates to cover the intersection point, individual covers of the individual cover units move toward a center of the intersection point and come into alignment.

13. The apparatus of claim 11, wherein the contact link comprises:
a first link rotatably installed, on the bracket, adjacent to a first path part of the at least two path parts and configured to extend such that the movable member moving in the first path part is configured to come into contact with the first link;
a second link rotatably installed, on the bracket, adjacent to a second path part of the path parts and configured to extend such that the movable member moving in the second path part is configured to come into contact with the second link; and
a third link configured to rotate in conjunction with a rotation of the first link or the second link, and to which the cover is connected in an interlocking manner.

14. The apparatus of claim 13, wherein the first link includes: a first end extending along the path of the first path part, and a second end rotatably installed on the bracket, and
wherein the second end is formed with a first connection part configured to rotate the third link when the first link rotates due to the movable member entering the intersection point.

15. The apparatus of claim 13, wherein the cover comprises:
a barrier configured to cover a portion of the intersection point; and
a connection link including a first end connected to the barrier and a second end connected to the third link.

16. The apparatus of claim 15, wherein the barrier is configured to be in contact with the movable member.

17. The apparatus of claim 15, wherein the third link is formed with a longitudinally extending link connection hole, and the connection link is formed with an operation pin extended to be inserted into the longitudinally extending link connection hole.

18. The apparatus of claim 17, wherein the second link includes: a first end configured to contact the movable member and a second end rotatably installed on the bracket, and
wherein the second end is formed with a second connection part configured to contact the operation pin and move the cover when the second link rotates due to the movable member entering the intersection point.

19. The apparatus of claim 15, wherein:
the connection link is extended in a curved shape, and
the bracket is formed with a guide groove configured to guide a movement of the connection link along a path corresponding to the curved shape of the connection link.

20. The apparatus of claim 13, further comprising a restoration member provided on the bracket and configured to be connected to each of the first link and the second link, such that the first link and the second link are restored to a position where the first link and the second link contact the movable member.
